(19) United States
(12) Patent Application Publication
(10) Pub. No.: US 2024/0293880 A1
(43) Pub. Date: Sep. 5, 2024

(54) GUIDE DRESSER FOR SAW GUIDES

(71) Applicant: Precision Guide Machinery and Repair Limited, Prince George (CA)

(72) Inventors: Carrick BERGEN, Prince George (CA); Nalynd VOGT, Prince George (CA); Nathan PACHOLKO, Prince George (CA)

(21) Appl. No.: 18/590,684

(22) Filed: Feb. 28, 2024

Related U.S. Application Data
(60) Provisional application No. 63/449,163, filed on Mar. 1, 2023.

(51) Int. Cl. B23D 51/02; B23D 51/20

(52) U.S. Cl. CPC B23D 51/025; B23D 51/20

(57) ABSTRACT

A guide dresser for cutting or machining a saw guide includes a carriage assembly on which the saw guide is mounted. The carriage assembly includes a faceplate and a retaining plate for engaging opposed surfaces of the saw guide. A rod extends from the faceplate through the saw guide and the retaining plate, with at least a portion of the rod being threaded. A load cell is placed against the retaining plate and a nut is threaded along the rod until the saw guide is clamped against the faceplate. The load cell is able to convert the force exerted by the nut against the load cell into an electrical signal. The electrical signal is transmitted to a computer, which is able to determine a measurement of the torque exerted by the nut.

### CROSS-REFERENCE TO RELATED APPLICATIONS

This application claims the benefit of United States Provisional Patent Application No. 63/449,163 filed 1 Mar. 2023, the contents of which are hereby incorporated by reference.

### TECHNICAL FIELD

The present disclosure relates to guide dressers for saw guides, and in particular, to safety systems for guide dressers.

### BACKGROUND

In a gang saw, a plurality of parallel circular saw blades are mounted on a rotating arbor to form a gang saw assembly. A saw guide assembly is provided for each gang saw assembly, with the saw guide assembly comprising a plurality of saw guides attached to a guide post. The saw guides and the saw blades are configured such that each saw blade interacts with the saw guide assembly in between two adjacent saw guides. The saw blades rotate at high speeds in order to cut logs into individual boards. The opposing surfaces of the saw guides are configured to provide lubrication to the saw blades, in order to cool the rotating saw blades. Reference is made to U.S. Patent Publication No. 2022/0184720 filed Dec. 14, 2021, the contents of which are hereby incorporated by reference.

Typically, support pads made from Babbitt material are attached to one or both of the opposing surfaces of the saw guide. It is sometimes necessary to machine the surfaces of the saw guide in order to ensure that the support pads provide a substantially flat surface for the rotating saw blades. In addition, the surfaces of the support pads should be substantially parallel to each other. This machining of the saw guide may be performed using a guide dresser. In a conventional guide dresser, the saw guide is securely clamped to a moveable carriage. The carriage may be moved in between two cutting tools, which are able to precisely and accurately machine the opposing surfaces of the saw guide.

However, it is important that the saw guide be properly clamped to the carriage before cutting operations are commenced. The saw guide should be clamped sufficiently securely to the carriage such that the saw guide will not vibrate or chatter during the cutting operations. If the saw guide is not clamped sufficiently securely to the carriage, the saw guide may shift or move during cutting operations, resulting in improper machining of the surfaces and/or damage to the guide dresser. Even worse, the saw guide may become detached from the guide dresser and be ejected from the guide dresser, causing a significant hazard to the operator and other workers. If, however, the saw guide is clamped too tightly to the carriage, the stress imparted may cause damage to the saw guide and/or the guide dresser.

### SUMMARY

In one embodiment, a guide dresser for cutting or machining a saw guide comprises a pair of cutting assemblies, a carriage assembly, and a computer. Each of the cutting assemblies comprises one or more cutting members configured for cutting or machining the saw guide. The carriage assembly is adapted to receive the saw guide and to move in between the cutting assemblies for cutting or machining the saw guide. The carriage assembly comprises a faceplate, a rod, a retaining plate, a load cell, and a nut. The faceplate is adapted to engage a first surface of the saw guide. The rod extends from the faceplate and comprises a threaded portion. The retaining plate is adapted to engage a second surface of the saw guide. The load cell adapted to engage with the retaining plate and to generate one or more electrical signals corresponding to the force exerted thereon. The nut is adapted to threadedly engage with the threaded portion and to enage with the load cell. The computer is in communications with the load cell and is configured to receive the one or more electrical signals and to convert the one or more electrical signals into measurements of the torque exerted by the nut on the load cell. The computer is further configured to prevent movement of the carriage assembly unless the measurements of the torque is between a predetermined minimum level and a predetermined maximum level.

In another embodiment, the guide dresser further comprises a guide locator attached to the faceplate. The guide locator is adapted to engage with the saw guide to orient the saw guide in a particular orientation on the faceplate.

In still another embodiment, the retaining plate comprises a retaining plate opening adapted to engage with the rod therethrough.

In still yet another embodiment, the load cell comprises a load cell opening adapted to engage with the rod therethrough.

In a further embodiment, the rod comprises a rod end, and the threaded portion extends from the rod end.

In still a further embodiment, the computer communicates with the load cell through a data cable between the computer and the load cell.

In still yet a further embodiment, the carriage assembly further comprises a support cable extending between the load cell and the carriage assembly. A length of the support cable prevents the load cell from striking a floor on which the guide dresser is located when the load cell is disengaged from the rod.

In another embodiment, the computer comprises a display, with the display configured to display the measurements of torque exerted by the nut.

In still another embodiment, the display is further configured to display an activatable button for commencing movement of the carriage assembly in between the cutting assemblies when the measurements of the torque is between the predetermined minimum level and the predetermined maximum level.

In another embodiment, one or both of the predetermined minimum level and the predetermined level are configured using the computer.

In a further embodiment, the cutting assemblies each comprises one or more cutting members for cutting or machining the saw guide.

In still a further embodiment, the guide dresser further comprises a housing between the cutting assemblies, with the housing comprising an opening through which the carriage assembly moves into before the cutting assemblies cut or machine the saw guide.

In still yet a further embodiment, a conversion of the one or more electrical signals into measurements of the torque exerted by the nut on the load cell may be determined, at least in part, through prior calibration of the load cell using a torque wrench.

In yet another embodiment, the computer communicates with the load cell through wireless communications between the computer and the load cell.

A guide dresser for cutting or machining a saw guide comprises a carriage assembly on which the saw guide is mounted. The carriage assembly comprises a faceplate and a retaining plate for engaging opposed surfaces of the saw guide. A rod extends from the faceplate through the saw guide and the retaining plate, with at least a portion of the rod being threaded. A load cell is placed against the retaining plate and a nut is threaded along the rod until the saw guide is clamped against the faceplate. The load cell is able to convert the force exerted by the nut against the load cell into an electrical signal. The electrical signal is transmitted to a computer, which is able to determine a measurement of the torque exerted by the nut.

In a further embodiment, the computer is configured to cause a display to show the measurement of the torque exerted by the nut.

In another embodiment, the computer is configured to not allow the operator to commence cutting or machining operations by the guide dresser unless the measurement of the torque exerted by the nut is within a predetermined range.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 shows a guide dresser in accordance with one embodiment;

FIG. 2 is another view of the guide dresser of FIG. 1, showing the interior of the cutting assemblies;

FIG. 3 shows a saw guide;

FIG. 4 is a partial view of the guide dresser of FIG. 1;

FIG. 5 is a partial end view of the guide dresser of FIG. 2;

FIG. 6 is a partial end view of the guide dresser of FIG. 1;

FIG. 7 is a partial view of the guide dresser of FIG. 1, showing a saw guide mounted to the guide dresser; and

FIG. 8 is a sectional partial view of the guide dresser of FIG. 1, showing a saw guide mounted to the guide dresser.

### DETAILED DESCRIPTION

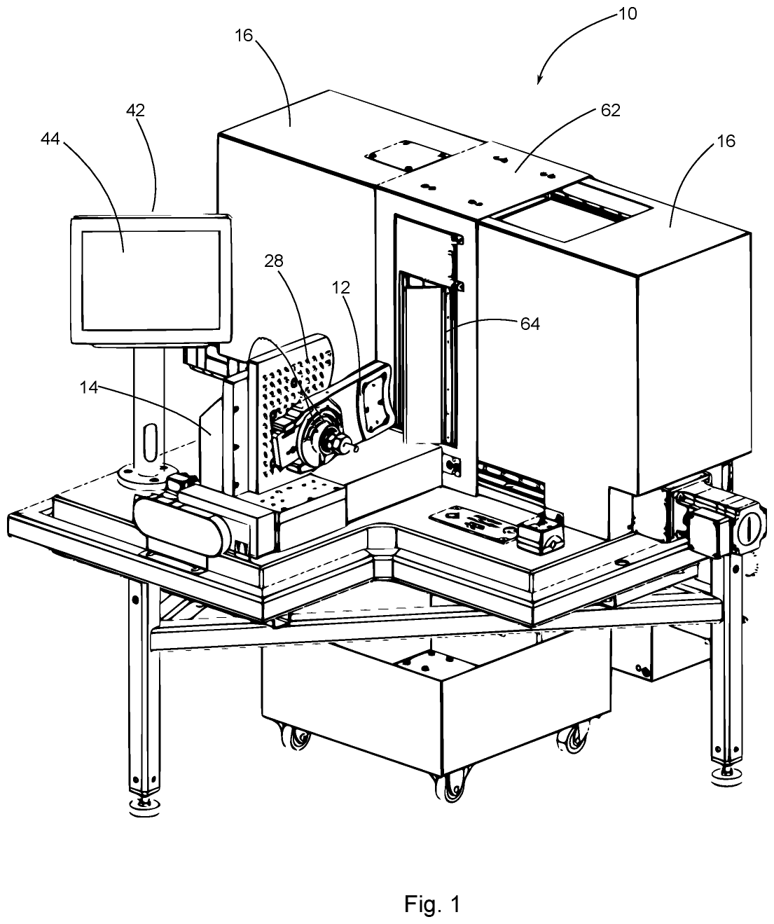

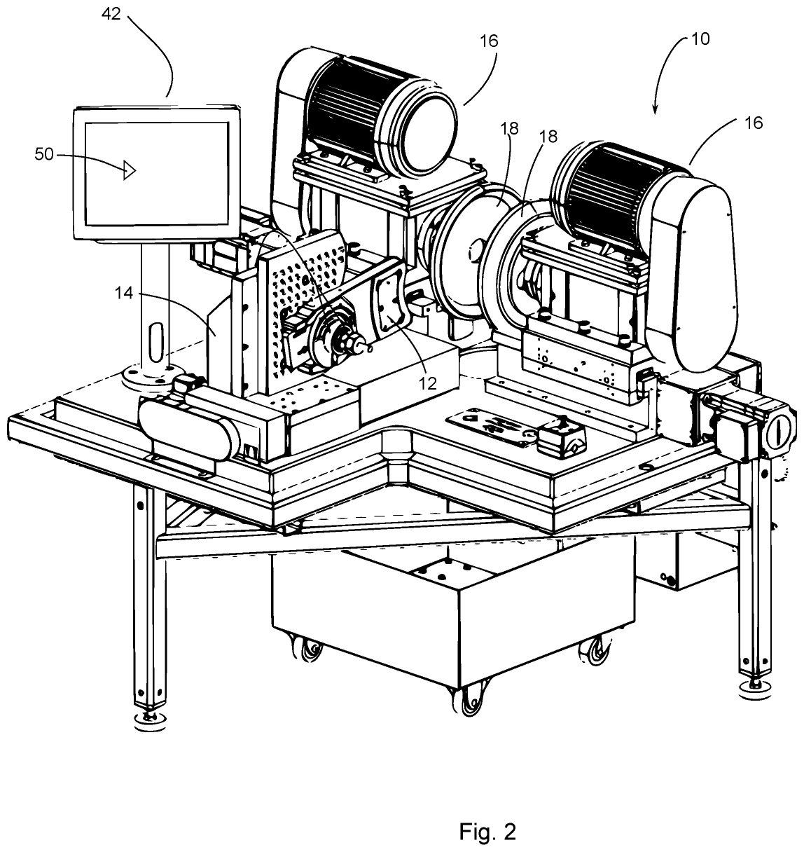

Referring to FIGS. 1 and 2, a guide dresser 10 in accordance with one embodiment is configured to cut or machine a saw guide 12. The guide dresser 10 comprises a carriage assembly 14, to which the saw guide 12 may be mounted, and a pair of cutting assemblies 16. The carriage assembly 14 is configured to move the saw guide 12 out of and in between the cutting assemblies 16. Each of the cutting assemblies comprises one or more cutting members 18, as best seen in FIG. 2, which depicts the interior of the cutting assemblies 16. The cutting members 18 are configured to cut or machine the saw guide 12.

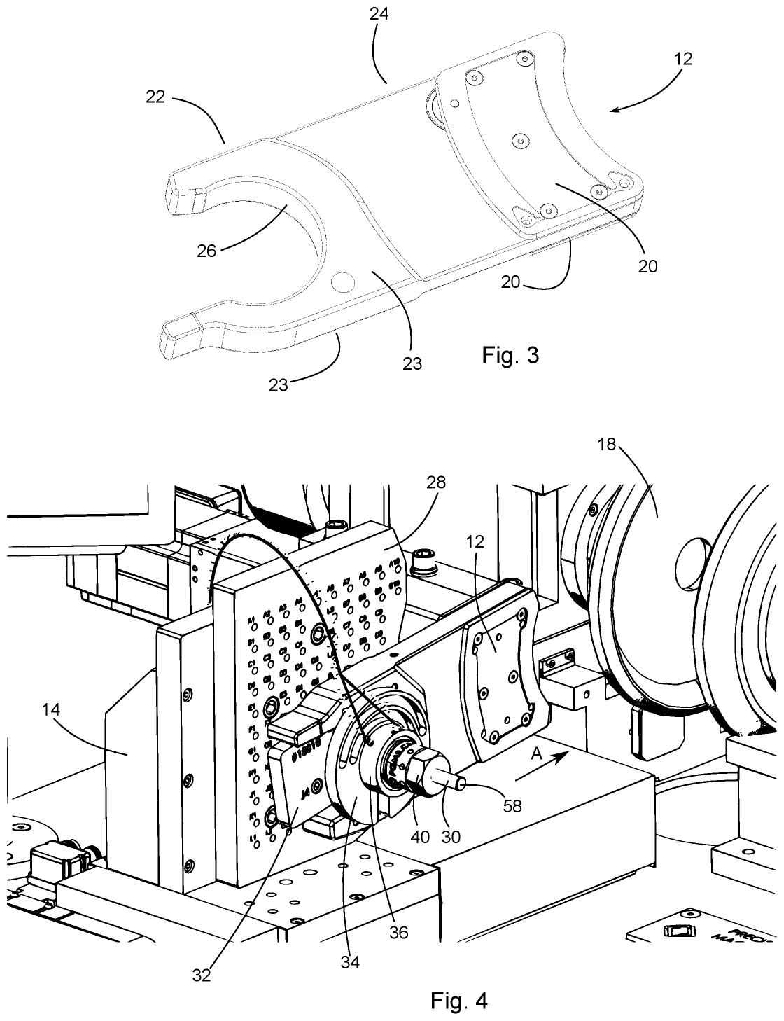

In particular, referring to FIG. 3, the saw guide 12 comprises two opposed guide surfaces 20, with each of the cutting members 18 configured to cut or machine one of the guide surfaces 20. The saw guide 12 may be mounted to the carriage assembly 14 while the carriage assembly 14 is clear of the cutting assemblies 16 (such as shown in FIG. 1). When operation of the guide dresser 10 is commenced, the carriage assembly 14 will move the saw guide 12 into position between the cutting assemblies 16. As the saw guide 12 is moved between the cutting members 18, the cutting members 18 will cut and machine the guide surfaces 20.

FIG. 3 depicts an embodiment of the saw guide 12. The saw guide 12 comprises a guide head 22 and a guide body 24, with the guide head 22 attached to the guide body 24. The guide head 22 comprises an inner curved portion 26 that is adapted to engage with a guide post in a saw guide assembly. The guide surfaces 20 may be located on the guide body 24. The guide head 22 may comprise two opposed head surfaces 23. The head surfaces 23 are adapted to engage with adjacent ones of the saw guides 12 when mounted in the saw guide assembly.

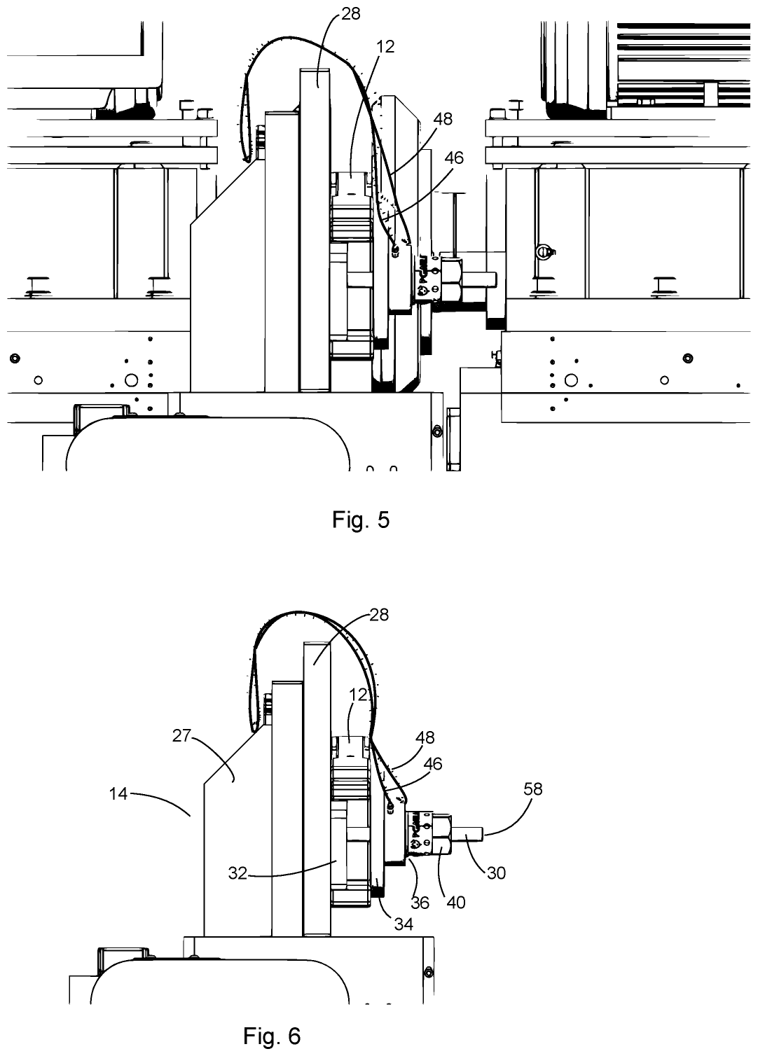

Referring to FIGS. 4 to 8, the carriage assembly 14 comprises base 27 and a faceplate 28 attached to the base 27. The saw guide 12 is mountable on the faceplate 28. The faceplate 28 may be adapted to engage with a first one of the head surfaces 23. The carriage assembly 14 further comprises a rod 30 extending from or through the faceplate 28. The rod 30 may be substantially cylindrical (i.e. with a substantially circular cross-section) and comprises a rod end 58 and a threaded portion 52 that extends for at least a portion of the rod 30. In some embodiments, the threaded portion 52 may extend from the rod end 58. The rod 30 may extend within the inner curved portion 26 of the guide head 22 when the saw guide 12 is mounted to the faceplate 28 (as seen, for example, in FIG. 4).

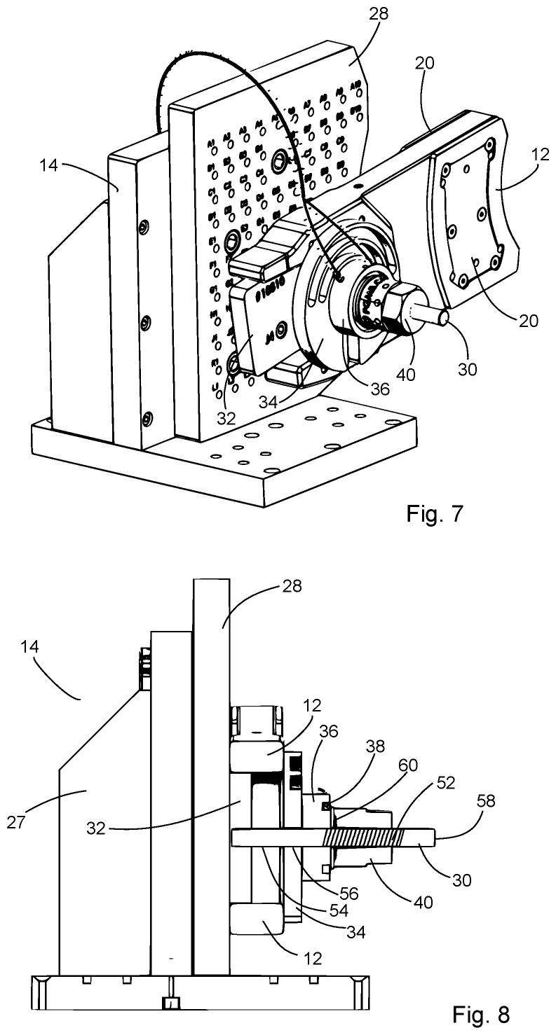

Furthermore, the carriage assembly 14 may comprise a guide locator 32 that is attached to the faceplate 28. In some embodiments, the guide locator 32 may be fixedly attached to the faceplate 28. The guide locator 32 may be sized to engage with at least a portion of the inner curved portion 26 of the guide head 22 when the saw guide 12 is mounted to the faceplate 28. This may assist in orienting the saw guide 12 into a desired position when mounted to the faceplate 28 (as shown in FIG. 7) and helps to prevent the saw guide 12 from shifting or otherwise moving when mounted onto the faceplate 28. Depending on the size of the guide locator 32, the rod 30 may extend through the guide locator 32.

The carriage assembly 14 further comprises a retaining plate 34 that is adapted to fit around the rod 30 and against a second one of the head surfaces 23. The retaining plate 34 may be annular, comprising a retaining plate opening 54 that is larger than a diameter of the rod 30 so as to allow the retaining plate 34 to slide along the rod 30.

The carriage assembly 14 further comprises a load cell 36 is also adapted to fit around the rod 30 and to sit against the retaining plate 34. The load cell 36 may be annular, comprising a load cell opening 56 that is larger than a diameter of the rod 30 so as to allow the load cell 36 to slide along the rod 30. The load cell 36 comprises a cell surface 38 that is adapted to convert a force exerted on the cell surface 38 into an electrical signal.

Referring to FIG. 8, the carriage assembly 14 further comprises a nut 40. The load cell 36 may be located between the retaining plate 34 and the nut 40. The nut 40 may be adapted to threadedly engage with the threaded portion 52 of the rod 30. The nut 40 comprises a nut end 60 that may be tightened against the load cell 36, which in turn will clamp the retaining plate 34 against the saw guide 12 and against the faceplate 28.

In order to clamp the saw guide 12 to the carriage assembly 14, the saw guide 12 may first be placed against the faceplate 28, with the inner curved portion 26 of the guide head 22 fitted around the guide locator 32. The retaining plate 34 may then be inserted around the rod end 58 and slid along the rod 30 until it engages against the saw guide 12. The load cell 36 may then be inserted around the rod end 58 and slid along the rod 30 until it engages against the retaining plate 34.

The nut 40 may then be inserted around the rod end 58. If the threaded portion 52 extends from the rod end 58, the nut 40 may be threaded along the threaded portion 52 until the nut 40 presses against the cell surface 38. Alternatively, if the threaded portion 52 does not extend from the rod end 58, the nut 40 may be slid along the rod 30 until it reaches the threaded portion 52, at which time the nut 40 may be threaded along the threaded portion 52 until the nut 40 presses against the cell surface 38.

When the nut 40 presses against the cell surface 38, the saw guide 12 will be held in place against the faceplate 28. The nut 40 may be further threaded along the threaded portion 52 to further tighten the saw guide 12 against the faceplate 28. In this manner, the saw guide 12 is clamped against the faceplate 28 in order to secure the saw guide 12 to the carriage assembly 14. In some embodiments, the clamping of the saw guide 12 to the carriage assembly 14 is performed while the carriage assembly 14 is clear of the cutting assemblies 16.

Referring to FIG. 2, the guide dresser 10 further comprises a computer 42 that is configured to receive and process the electrical signals generated by the load cell 36. In one embodiment, the load cell 36 transmits the electrical signals (corresponding to the force applied on the cell surface 38) to a voltage amplifier that amplifies the electrical signals before transmitting them to the computer 42. Alternatively, the load cell 36 may transmit the electrical signals directly to the computer 42. The transmission of the electrical signals from the load cell 36 to the voltage amplifier and/or the computer 42 may be through wired (such as using a data cable 46) or wireless communications. Wireless communications may be through Bluetooth, Wi-Fi, or any other suitable wireless communications protocol.

As the nut 40 is threaded along the threaded portion 52 against the load cell 36, the nut end 60 exerts a force against the cell surface 38. This force is converted to an electrical signal by the load cell 36 that is eventually received by the computer 42. The computer 42 is configured to convert the electrical signal into a measurement of the torque exerted by the nut 40. The conversion may be assisted by prior calibration of the load cell 36 using a torque wrench. The computer 42 may comprise a display 44 that is configured to display, among other things, the measurement of the torque exerted by the nut 40. In other embodiments, the display 44 may be separate from the computer 42. The computer 42 may be configured to accept input from an operator, such as through a keyboard, a mouse, a touchscreen, or other input devices.

As the nut 40 is continued to be threaded (along the threaded portion 52) against the load cell 36, the nut 40 exerts an increased force on the cell surface 38 of the load cell 36, which results in the electrical signal transmitted by the load cell 36 changing to reflect this increased force. The computer 42 is configured to determine the measurement of the (increased) torque and to cause the display 44 to display the updated measurement of the torque exerted by the nut 40. In this manner, the computer 42 is able to continually monitor the measurement of the torque exerted by the nut 40 and to update the display 44 accordingly.

The computer 42 may be configured to include a minimum acceptable level of torque exerted by the nut 40 and a maximum acceptable level of torque exerted by the nut 40 (corresponding approximately to the minimum acceptable level of tightness of the saw guide 12 against the faceplate 28 and to the maximum acceptable level of the tightness of the saw guide 12 against the faceplate 28, respectively). The range of torque levels between the minimum acceptable level and the maximum acceptable level reflect a degree of clamping force of the saw guide 12 to the carriage assembly 14 that is considered to be within a safe tolerance for operation of the guide dresser 10.

The computer 42 may also be configured to determine whether the electrical signal received from the load cell 36 corresponds to a measurement of the torque exerted by the nut 40 that is below the minimum acceptable level or that is greater than the maximum acceptable level. In such circumstances, the computer 42 may be configured to prevent the operation of the cutting assemblies 16 from commencing.

When the computer 42 determines that the electrical signal received from the load cell 36 corresponds to a measurement of the torque exerted by the nut 40 that is below the minimum acceptable level, this is an indication that the saw guide 12 may not be sufficiently secured against faceplate 28. The computer 42 may be configured to display a warning on the display 44 indicating that the nut 40 is not tight enough and alerting the operator to increase the tightness of the nut 40.

In some embodiments, the computer 42 may be configured to cause the display 44 to display a button 50 that allows the operator to commence operation of the guide dresser 10. For example, the button 50 may be a clickable button that the operator is able to click (e.g. using a mouse) or otherwise activate. This may cause the carriage assembly 14 (with the saw guide 12 mounted on the faceplate 28) to move into position in between the cutting assemblies 16 to allow for the cutting and machining actions. For example, when the button 50 is clicked or otherwise activated, the computer 42 may cause the carriage assembly 14 to move in direction A (as shown in FIG. 4) towards and in between the cutting assemblies 16. In some embodiments, the guide dresser 10 may comprise a housing 62 between the cutting assemblies 16. The housing 62 comprises a housing opening 64 through which the carriage assembly 14 may move. When the carriage assembly 14 is within the housing 62 and between the cutting assemblies 16, the cutting members 18 in the cutting assemblies 16 may cut or machine the guide surfaces 20. When the cutting or machining of the guide surfaces 20 is complete, the computer 42 may cause the carriage assembly 14 to move out from the housing 62 through the housing opening 64 (e.g. back into the position shown in FIG. 1).

However, the computer 42 may be configured to only cause the button 50 to be displayed on the display 44 when the electrical signal received from the load cell 36 corresponds to a measurement of the torque exerted by the nut 40 that is greater than the minimum acceptable level and less than the maximum acceptable level. This ensures that the operator is not able to commence operation of the guide dresser 10 until the saw guide 12 is clamped within an acceptable level of torque.

When the electrical signal received from the load cell 36 corresponds to a measurement of the torque exerted by the nut 40 that is greater than the minimum acceptable level and less than the maximum acceptable level, the computer 42 is configured to allow for the operation of the guide dresser 10 (i.e. the cutting and machining of the guide surfaces 20) to commence. For example, the computer 42 may be configured to cause the button 50 to be displayed on the display 44.

If the nut 40 is continued to be threaded (along the threaded portion 52) against the load cell 36, the computer 42 is configured to keep the button 50 displayed on the display 44 as long as the electrical signal received from the load cell 36 corresponds to a measurement of the torque exerted by the nut 40 that is less than the maximum acceptable level. However, if the computer 42 detects that the electrical signal received from the load cell 36 corresponds to a measurement of the torque exerted by the nut 40 that exceeds the maximum acceptable level (e.g. the nut 40 is too tight), the computer 52 is configured to cease display of the button 50 on the display 44. The computer 52 may be configured to display a warning on the display 44 indicating that the nut 40 is too tight and alerting the operator to reduce the tightness of the nut 40. By no longer displaying the button 50 on the display 44, the operator is unable to commence operation of the guide dresser 10 when the nut 40 is too tight.

In some embodiments, the threaded portion 52 extends for at least a sufficient portion of the rod 30 such that the nut 40 is within the threaded portion 52 when the saw guide 12 is clamped onto the faceplate 28.

In some embodiments, the minimum acceptable level of torque exerted by the nut 40 may be between approximately 25 and 40 ft-lb. The maximum acceptable level of torque exerted by the nut 40 may be approximately 50 ft-lb. However, it is understood that the minimum and maximum acceptable levels of torque may also be pre-set by the operator using the computer 42, as the operator deems appropriate.

The mounting of the head surface 23 against the faceplate 28 allows the guide dresser 10 to accurately and precisely machine the guide surfaces 20 to within a desired tolerance relative to the head surfaces 23.

Referring to FIGS. 4 to 6, a support cable 48 may be attached between the load cell 36 and the carriage assembly 14, such as for example, the faceplate 28. A length of the support cable 48 may be selected so as to prevent the load cell 36 from striking the floor (and thereby damaging the load cell 36) when the load cell 36 is released from the rod 30 (e.g. when no longer secured to the rod 30). In one embodiment, the support cable 48 may be bundled with or connected to the data cable 46, at least for a portion of their respective lengths.

It will be appreciated by those skilled in the art that the preferred embodiments have been described in some detail but that certain modifications may be practiced without departing from the principles of the invention.

1. A guide dresser for cutting or machining a saw guide, the guide dresser comprising:
a pair of cutting assemblies, each of the cutting assemblies comprising one or more cutting members configured for cutting or machining the saw guide;
a carriage assembly adapted to receive the saw guide and to move in between the cutting assemblies for cutting or machining the saw guide, the carriage assembly comprising:
a faceplate adapted to engage a first surface of the saw guide;
a rod extending from the faceplate, the rod comprising a threaded portion;
a retaining plate, the retaining plate adapted to engage a second surface of the saw guide;
a load cell, the load cell adapted to engage with the retaining plate and to generate one or more electrical signals corresponding to the force exerted thereon; and
a nut, the nut adapted to threadedly engage with the threaded portion and to enage with the load cell;
a computer in communications with the load cell, wherein the computer is configured to receive the one or more electrical signals and to convert the one or more electrical signals into measurements of the torque exerted by the nut on the load cell, and wherein the computer is further configured to prevent movement of the carriage assembly unless the measurements of the torque is between a predetermined minimum level and a predetermined maximum level.

2. The guide dresser of claim 1 further comprising a guide locator attached to the faceplate, the guide locator adapted to engage with the saw guide to orient the saw guide in a particular orientation on the faceplate.

3. The guide dresser of claim 1, wherein the retaining plate comprises a retaining plate opening adapted to engage with the rod therethrough.

4. The guide dresser of claim 1, wherein the load cell comprises a load cell opening adapted to engage with the rod therethrough.

5. The guide dresser of claim 1, wherein the rod comprises a rod end, and wherein the threaded portion extends from the rod end.

6. The guide dresser of claim 1, wherein the computer communicates with the load cell through a data cable between the computer and the load cell.

7. The guide dresser of claim 4, wherein the carriage assembly further comprises a support cable extending between the load cell and the carriage assembly, wherein a length of the support cable prevents the load cell from striking a floor on which the guide dresser is located when the load cell is disengaged from the rod.

8. The guide dresser of claim 1, wherein the computer comprises a display, the display configured to display the measurements of torque exerted by the nut.

9. The guide dresser of claim 8, wherein the display is further configured to display an activatable button for commencing movement of the carriage assembly in between the cutting assemblies when the measurements of the torque is between the predetermined minimum level and the predetermined maximum level.

10. The guide dresser of claim 1, wherein the guide dresser further comprises a display, the display connected to the computer and configured to display the measurements of torque exerted by the nut.

11. The guide dresser of claim 10, wherein the display is further configured to display an activatable button for commencing movement of the carriage assembly in between the cutting assemblies when the measurements of the torque is between the predetermined minimum level and the predetermined maximum level.

12. The guide dresser of claim 1, wherein one or both of the predetermined minimum level and the predetermined level are configured using the computer.

13. The guide dresser of claim 1, wherein the cutting assemblies each comprises one or more cutting members for cutting or machining the saw guide.

14. The guide dresser of claim 1, wherein the guide dresser further comprises a housing between the cutting assemblies, the housing comprising an opening through which the carriage assembly moves into before the cutting assemblies cut or machine the saw guide.

15. The guide dresser of claim 1, wherein a conversion of the one or more electrical signals into measurements of the torque exerted by the nut on the load cell may be determined, at least in part, through prior calibration of the load cell using a torque wrench.

16. The guide dresser of claim 1, wherein the computer communicates with the load cell through wireless communications between the computer and the load cell.
